(19) United States
(12) Patent Application Publication
(10) Pub. No.: US 2006/0123859 A1
(43) Pub. Date: Jun. 15, 2006

(54) Mortise lock with automatic projection of dead bolt

(76) Inventor: Fermin Gomez Gonzalez, Irun (ES)

Correspondence Address: NIELDS & LEMACK, 176 EAST MAIN STREET, SUITE 7, WESTBORO, MA, 01581, US

(21) Appl. No.: 11/010,533

(22) Filed: Dec. 13, 2004

(51) Int. Cl. E05B 59/00; E05B 63/14

(52) U.S. Cl. 70/107

(57) ABSTRACT

A mortise lock with automatic projection of dead bolt, which comprises a trigger support (7), a dead bolt retaining control (8), a control retaining catch (9), a rocking lever (10), a latch bolt stop (11), and an antipanic arm (12); wherein the trigger support (7) has suitable means of blocking an operating vertical slide of the dead bolt retaining control (8), which has a mount that slides vertically by gravity between respective upper and lower positions corresponding to the retracted and extended states, respectively, of the dead bolt (1); this dead bolt retaining control (8) also incorporates several means of hooking that operate in conjunction with the retaining catch of the control (9), other means that operate in conjunction with means of the trigger (3) suitable for blocking its operating vertical slide, other means of retention of the retracted state of the dead bolt (1) that operate in conjunction with a first stub (13) of the dead bolt lockplate (1a), and other means of reciprocal propulsion with respect to this first stub (13) of the dead bolt lockplate (1a).

This invention relates to a mortise lock that is automatic, that is, that brings about the automatic projection of the locking dead bolt when the door in which it is installed is brought into its shut position in its frame.

In particular, the lock of the invention corresponds to a general construction provided with a dead bolt, a latch bolt, a trigger that is situated between the dead bolt and the latch bolt and that, when the door is brought into its frame and when this latch bolt retracts, is operatively retractable against a first spring, a guard, a follower for an actuating knob, and a cylinder for a combination key, wherein the dead bolt of the lock can be retracted to actuate the follower, can be retracted to actuate the cylinder, and is mounted in the back point of a dead bolt lockplate, the top edge of which has several stop means of the respective retracted and extended positions of this dead bolt; the latch bolt of the lock can be retracted to actuate the follower or the cylinder, the trigger of the lock lacks an opening in the strike plate in the doorframe, and the guard of the lock has a projection transverse to the dead bolt lockplate, which, by vertical displacement, is capable of operating or not in conjunction with said stop means of the retracted and extended positions of the dead bolt.

The general operation of an automatic lock is based on the fact that the trigger lacks an opening in the strike plate in the doorframe and actuates in conjunction with a lock mechanism that prevents the dead bolt from projecting while, when the door meets the frame, the latch bolt and the trigger itself are retracted elastically and that, once the door has attained its final shut position, the projection of the latch bolt and the impossibility of projection of the trigger combine to enable the dead bolt to project, pushed by its own spring. In emergency situations, in order to prevent the user from being locked in, these locks incorporate a so-called “antipanic” mechanism that permits the lock (dead bolt and latch bolt) to be opened completely without the necessity of a key, simply by activating the knob or handle.

A drawback of these locks is that they involve a great precision in construction itself and in the external elements (frame, strike plates) so that the locking action occurs in a perfect manner, without any malfunctions.

Owing to the above and to the complexity of the mechanism due to the large number and complicated configuration of the parts, another drawback of these automatic locks is their high cost.

Another thing is that it is known that the dead bolt is locked in its two operating positions, namely, retracted and extended: in the retracted position for countering the action of its opposing spring; and in the extended position to prevent its being retracted by the introduction of a screwdriver or the like, a system typically employed by burglars to force open a locked door. Nonetheless, this latter locking of the extended position can be deactivated by means of introducing into the back end of the strike plate of the dead bolt something that prevents the dead bolt from totally projecting; by this means, this extended position would not stay locked and the dead bolt could be retracted by the same above process of inserting a screwdriver or the like.

In contrast to this state of affairs, the lock proposed in the present invention presents a construction that comprises a trigger support, a dead bolt retaining control, a control retaining catch, a rocking lever, a latch bolt stop, and an antipanic arm; wherein said trigger support has suitable means of blocking an operating vertical slide of the dead bolt retaining control, said dead bolt retaining control has a mount that slides vertically by gravity between respective upper and lower positions corresponding to the retracted and extended states, respectively, of the dead bolt, this dead bolt retaining control also incorporates several means of hooking that operate in conjunction with the retaining latch of the control, other means that operate in conjunction with said means of the trigger capable of blocking its operating vertical slide, other means of retention of the retracted state of the dead bolt that operate in conjunction with a first stub of the dead bolt lockplate, and other means of reciprocal propulsion with respect to this first stub of the dead bolt lockplate; said control retaining catch travels with the latch bolt and has a tilting mount that is transverse to the plane of the dead bolt retaining control and that operates between a tilted position situated just below the means of hooking of the dead bolt retaining control and a non-tilted position against a spring that is held at its spring excursion; said rocking lever has an arm provided with a guide track, in which a second stub, installed in the guard, moves in an adjusting manner and, in its other arm, has a first face, which, in relation to the rotation of the opening action of the locked lock, adopts a non-tilted position, pushed by a second spring, in which it is positioned in front of a peripheral projection of the follower, said latch bolt stop has a mount that tilts with respect to a central axis and has several means capable of interfering or not interfering with the retraction of the latch bolt to determine respective positions of stopping and release, and said antipanic arm has a tilting first-degree dead-bolt mount with an articulation that is in common with that of the rocking lever and that has an arm positioned in front of a third stub installed in the dead bolt lockplate and, in the other arm, has a second face that, in relation to said operating rotation of the follower starting from the locked state of the lock, is suitably retracted with respect to the first face of the rocking lever, there being a multiplication of this antipanic arm such that it produces the course of retraction of the dead bolt appropriately before, during the same rotation of the follower, the realization of the total retraction of the latch bolt is accomplished.

In accordance with the invention, in said trigger support, the means of blocking the operating vertical slide of the dead bolt retaining control consist of a side lug that has an upper horizontal surface and a lower beveled surface; in this respect, in said dead bolt retaining control, the means of blocking its operating vertical displacement, which operate in conjunction with other means of the trigger, consist of several pivots, upper and lower, which, in relation to the extended and retracted positions of the trigger, stay respectively aligned or not aligned in the vertical direction, the upper pivot remaining opposite the horizontal and beveled surfaces of the side lug.

Other features of the invention referring to the dead bolt retaining control refer to the following: the means of hooking consist of a first hook that is just above the level of the tilted position of the control retaining catch and suitably retracted in relation to the start of the retraction travel distance of the latch bolt; the means of retention of the retracted state of the dead bolt consist of an angled opening that is opposite said first stub of the dead bolt lockplate and that is situated at a level suitably lower than that of this first stub in relation to said upper position of the dead bolt retaining control; and the means of reciprocal propulsion between the dead bolt and the first stub of the dead bolt lockplate consist of a ramp that is made in the front side of the dead bolt retaining control, joined in a continuous manner with the back edge of its angled opening.

Another feature of the invention is that said control retaining catch is installed in a carriage fastened in the tail end of the internal latch bolt to the case of the lock.

In order to explain the operation of the lock proposed, one starts from a position in which the door is released from its frame and the lock is opened, with its dead bolt retracted and with the latch bolt and the trigger in their extended positions. When the door is brought into the frame, the following sequence ensues: in schematic terms, the latch bolt commences its retraction prior to the trigger, performing an initial travel by itself and performing a final travel accompanied by the trigger; before the trigger commences its retraction, the dead bolt retaining control is stopped in is upper operating position, because the side lug of the first position is inserted vertically with respect to the upper pivot of the second position; during the initial travel of the latch bolt by itself, the control retaining catch (which travels in the carriage affixed to the tail end of the latch bolt) is exactly positioned in the lower edge of the first hook formed in the dead bolt retaining control; then, when the trigger produces its retraction and releases the stop exerted between said pivots, the dead bolt retaining control continues to its initial upper position due to the immobilizing action performed now by the control retaining catch; only when the door reaches its locking position in its frame is the latch bolt able to project toward its strike plate and, when this is accomplished, the control retaining catch is enabled to exercise its function and the dead bolt retaining control drops by the action of gravity itself, assisted by the force of a sixth spring; in the undescended position of the dead bolt retaining control, the retention of this dead bolt in its retracted position is provided by the housing of the first stub (installed in the dead bolt lockplate) in the angled opening of the dead bolt retaining control; when the latter drops, the retention is released at the same time that the ramp of the same is pushed over said first stub until the dead bolt is totally projected.

In this operation, it needs to be pointed out that the dead bolt projects only when the door has reached its correct shut position. This means that the projection of the dead bolt will be brought about in perfect alignment with its strike plate, without any malfunction; logically, this assumes that, during the initial installation of the door and lock, the strike plate has been placed in the correct position and, moreover, is independent of the dimensions of the doorframe in each case.

In this regard, it needs to be pointed out as well that this operational sequence is achieved by means of great simplicity, which can be constructed with the required precision in an easy manner. All of this results in a substantial reduction in the costs of production in relation to the prior art in this field.

Another important quality of the invention that is to be pointed out occurs in the resetting of the lock (initial operation for producing a new automatic closure). It consists in the fact that the retraction and stopping of the retracted dead bolt takes place even when the latch bolt is retracted halfway and, for that reason, the door cannot yet be released from the frame; this prevents a hasty or disorderly exit from causing the door to open without the dead bolt having been totally retracted and stopped, so that the dead bolt would continue to project, preventing the door from being able to reclose in its frame, that is, so that the door would stay open.

The invention also proposes an anti-retraction security device of the dead bolt for the case in which the dead bolt, during its automatic triggering, has not projected totally owing to the existence of some obstruction in the back end of its strike plate and is in an intermediate position not provided with a stop and, for this reason, is capable of being retracted by illicit means.

In order to thwart this possibility, it is provided, in accordance with the invention, that the stop means of the dead bolt lockplate are placed in the upper edge of the dead bolt lockplate forming, from front to back in a successively descending way, a first step, a second step, and a back groove, so that, assuming the dead bolt projects a few millimeters (for example, 10), it will still not be retractable by the system of introducing the point of a screwdriver and, nonetheless, will have sufficient projection to produce an effective closure.

Included in the case in which the dead bolt will be prevented from projecting is the case in which the closure will be assured by an anti-retraction security device of the latch bolt, which is established because, in the latch bolt stop, on one side and the other side of the central axis, there extend respective members, a first and a second, the first member being capable of rotating between raised and lowered positions, respectively, in which its end continues to interfere or not interfere with the retraction travel distance of the lateral projection of the retainer pusher at the time when, in relation to the opening rotation of the follower, the end of the second member is positioned directly on the peripheral dog of this follower or is suitably advanced toward the same at the time when, in said lowered position, the first member is positioned below with respect to a transverse hook provided in the support of the trigger, there existing a third spring that is positioned on the first member to counter the action produced by the opening rotation of the follower, which pushes the lowered position of the first member against this third spring. When the trigger is retracted (door shut in its frame), the transverse hook cannot prevent the first member of this latch bolt stop from being able to move to its raised position, driven by the third spring, so that, as soon as the latch bolt projects toward its strike plate, the end of the first member remains located slightly behind the lateral projection of the retainer pusher joined to this latch bolt; this distance behind the projection is so that, during the opening action (with handle or key), the start of the rotation of the follower produces a tilting of the latch bolt stop that is sufficient for the first member to remain retracted from the retraction travel distance of the latch bolt before said projection attains the position previously occupied by said first member. In this respect, it needs to be noted that the initial retraction travel distance of the latch bolt by itself also serves so that the lower edge of the retainer pusher itself prevents the first member from being able to move to its stop position when, owing to the retraction of the trigger, this possibility will be provided for the retraction of said transverse hook of the trigger support.

In order to better comprehend the nature of the present invention, we depict in the attached drawings, a preferred industrial embodiment, which is given merely by way of illustrative and non-limiting example.

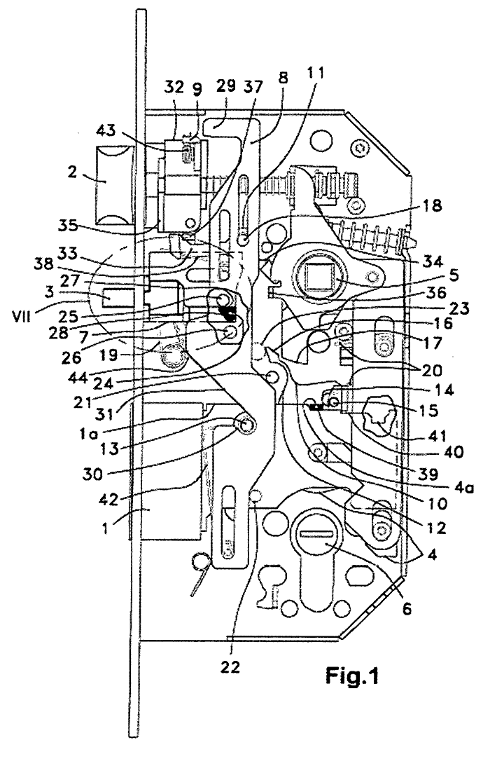

FIG. 1 shows a lock constructed according to the invention, viewed as if its side closest to the observer were transparent and showing the position in which the lock is open and the door is released from the frame; present in it is a conventional section of the dead bolt retaining control (8).

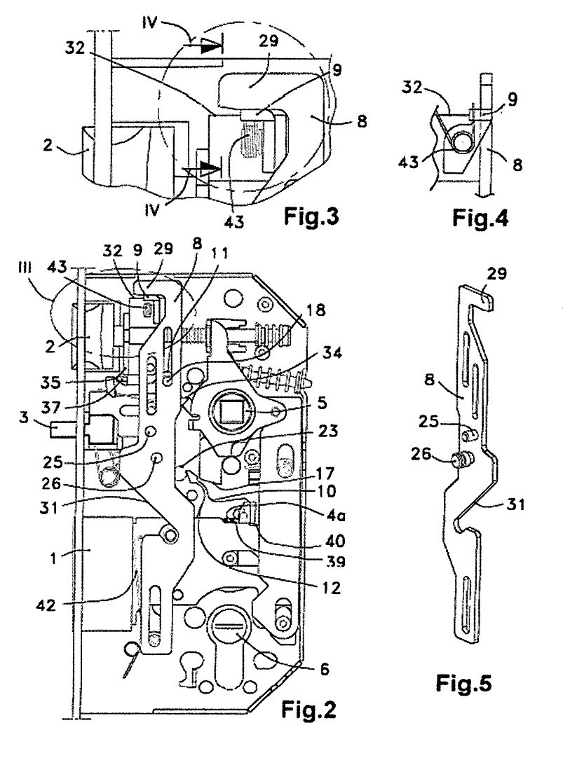

FIG. 2 is like FIG. 1, but it shows a position in which the latch bolt (2) is retracted, while the trigger (3) is extended.

FIG. 3 is an enlargement of the detail III circled in FIG. 2.

FIG. 4 is a view provided according to the arrows IV-IV highlighted inside the circle marked in FIG. 3.

FIG. 5 is a view that shows, in perspective, the dead bolt retaining control (1) at the side that provides the mechanism of the lock, that is, the opposite of the view in FIG. 1.

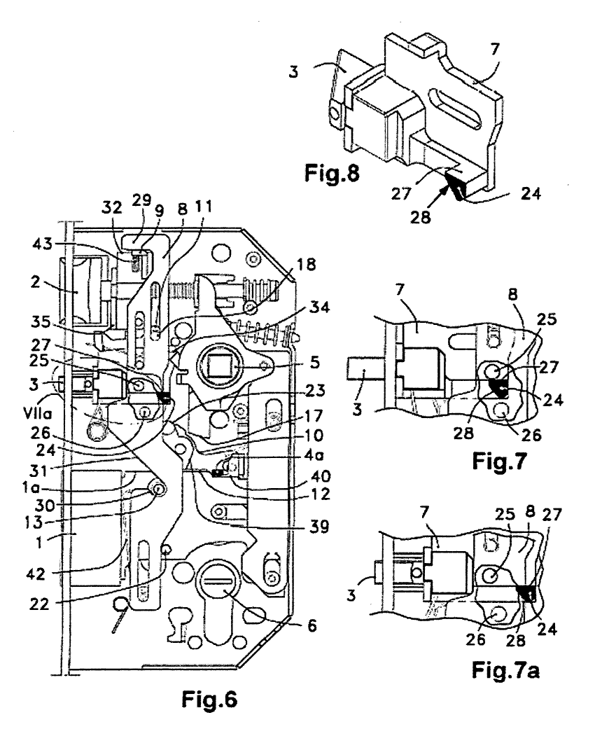

FIG. 6 is like FIG. 2, but also shows the retracted position of the trigger (3).

FIG. 7 is an enlargement of the detail VII circled in FIG. 1 and shows a conventional section of the dead bolt retaining control (8) for viewing directly the side lug (24) and the upper pivot (25) and lower pivot (26).

FIG. 7A is an enlargement of the detail VIIA highlighted in FIG. 6 and in a section like that in FIG. 7.

FIG. 8 is a view, in perspective, of the trigger subassembly (3) and the trigger support (7).

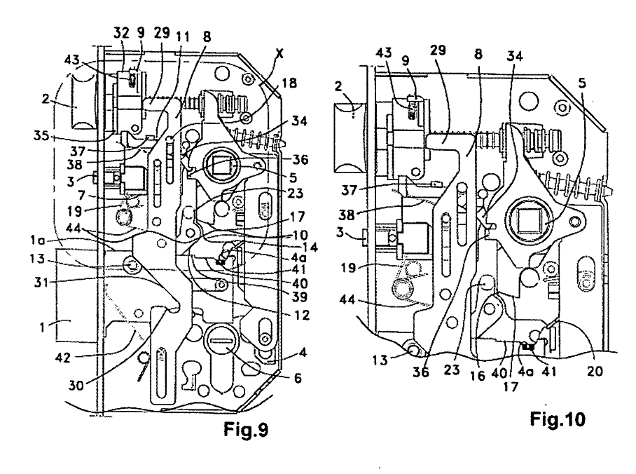

FIG. 9 is like FIG. 6, but shows the situation once the door has reached its shut position within the frame and the latch bolt (2) has projected to its strike plate, bringing about the automatic projection of the dead bolt (1).

FIG. 10 is an enlargement of the detail X that is circled in FIG. 9.

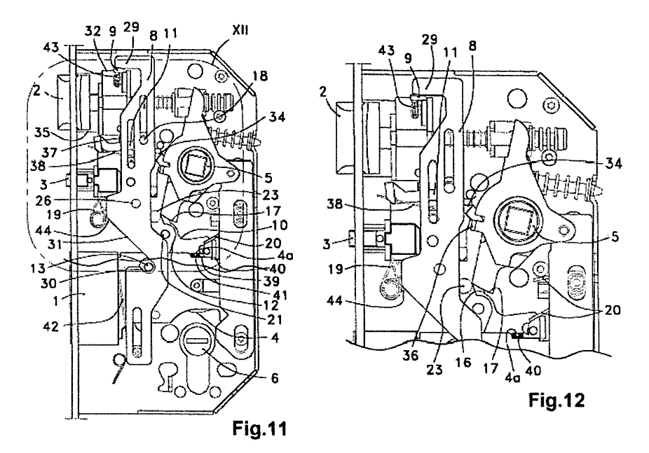

FIG. 11 is like FIG. 9, but shows a point in time of the opening action.

FIG. 12 is an enlargement of the detail XII circled in FIG. 11.

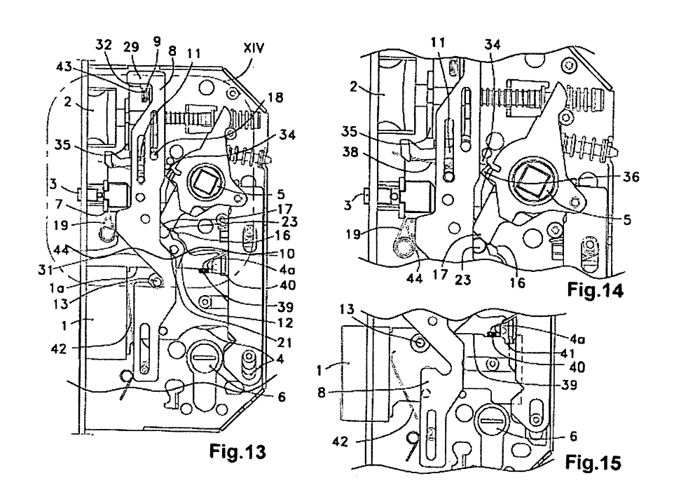

FIG. 13 is like FIG. 12, but refers to the conclusion of the opening action, still without the door releasing from the frame.

FIG. 14 is an enlargement of the detail XIV circled in FIG. 13.

FIG. 15 illustrates the intermediate anti-retraction security device of the dead bolt (1)

The following reference numbers are indicated in these figures:
1.—dead bolt
1a.—lockplate of dead bolt (1)
2.—latch bolt
3.—trigger
4.—guard
4a.—transverse projection of guard (4)
5.—follower
6.—cylinder
7.—support of trigger (3)
8.—retaining control of dead bolt (1)
9.—retaining latch of control (8)
10.—rocking lever
11.—stop of latch bolt (2)
12.—antipanic arm
13.—first stub, in dead bolt lockplate (1a)
14.—guide track of rocking lever (10)
15.—second stub, in guard (4)
16.—first face, in rocking lever (10)
17.—peripheral projection of follower (5)
18.—central axis of stop of latch bolt (11)
19.—first spring, for trigger
20.—second spring, for rocking lever (10) and guard (4)
21.—articulation
22.—third stub, in dead bolt lockplate (1a)
23.—second face, in antipanic arm (12)
24.—side lug of the trigger support (7)
25.—upper pivot of the dead bolt retaining control (8) for operation of control retainer
26.—lower pivot of the dead bolt retaining control (8) for spring support
27.—horizontal face of the side lug (24)
28.—beveled face of the side lug (24)
29.—first hook, in dead bolt retaining control (8)
30.—angled opening, in dead bolt retaining control (8)
31.—ramp of dead bolt retaining control (8)
32.—tail-end carriage of latch bolt (2)
33.—first member of latch bolt stop (11)
34.—second member of latch bolt stop (11)
35.—lateral projection of carriage (32)
36.—peripheral dog of follower (5)
37.—second hook, in trigger support (7)
38.—third spring, for stop of latch bolt (11)
39.—first step, in dead bolt lockplate (1a)
40.—second step, in dead bolt lockplate (1a)
41.—back groove, in dead bolt lockplate (1a)
42.—fourth spring, for dead bolt (1)
43.—fifth spring, for retaining latch (9)
44.—sixth spring, for dead bolt retaining control (8)

Illustrated in the following pages with respect to the drawings and reference numbers enumerated above is a preferred embodiment of the invention, referring to a mortise lock with automatic projection of dead bolt, which corresponds to a general construction provided with a dead bolt (1), a latch bolt (2), a trigger (3) that is situated between the dead bolt (1) and the latch bolt (2) and that, when the door is brought into its frame and when this latch bolt retracts, is operatively retractable against a first spring (19), a guard (4), a follower (5) for an actuating knob, and a cylinder (6) for a combination key, wherein dead bolt (1) of the lock can be retracted to actuate the follower (5), can be retracted to actuate the cylinder (6), and is mounted in the back point of a dead bolt lockplate (1a), the top edge of which has several stop means of the retracted and extended positions of this dead bolt (1), the latch bolt (2) of the lock can be retracted to actuate the follower (5) or the cylinder (6), the trigger (3) of the lock lacks an opening in the strike plate of the doorframe, and the guard (4) of the lock has a projection (4a) transverse to the dead bolt lockplate (1a), which, by vertical displacement, is capable of operating or not operating in conjunction with said stop means of the retracted and extended positions of the dead bolt (1).

In accordance with the invention, the claimed lock comprises (FIG. 1) a trigger support (7), a dead bolt retaining control (8), a control retaining catch (9), a rocking lever (10), a latch bolt stop (11), and an antipanic arm (12); wherein said trigger support (7) has means capable of blocking an operating vertical slide of the dead bolt retaining control (8), said dead bolt retaining control (8) has a mount that slides vertically by gravity between respective upper and lower positions corresponding to the retracted and extended states, respectively, of the dead bolt (1), this dead bolt retaining control (8) also incorporates several means of hooking that operate in conjunction with the retaining latch of the control (9), other means that operate in conjunction with said means of the trigger (3) capable of blocking its operating vertical slide, other means of retention of the retracted state of the dead bolt (1) that operate in conjunction with a first stub (13) of the dead bolt lockplate (1a), and other means of reciprocal propulsion with respect to this first stub (13) of the dead bolt lockplate (1a); said control retaining catch (9) travels with the latch bolt (2) and has a tilting mount that is transverse to the plane of the dead bolt retaining control (8) and that operates between a tilted position situated just below the means of hooking of the dead bolt retaining control (8) and a non-tilted position against a spring that is held at its spring excursion; said rocking lever (10) has an arm provided with a guide track (14), in which a second stub (15), installed in the guard (4), moves in an adjusting manner, and, in its other arm, has a first face (16), which, in relation to the rotation of the opening action of the locked lock, adopts a non-tilted position, pushed by a second spring (20), in which it is positioned in front of a peripheral projection (17) of the follower (5), said latch bolt stop (11) has a tilting mount with respect to a central axis (18) and has several means capable of interfering or not interfering with the retraction of the latch bolt (2) to determine respective positions of stopping and release, and said antipanic arm (12) has a tilting first-degree dead bolt mount with an articulation (21) that is in common with that of the rocking lever (10) and has an arm positioned in front of a third stub (22) installed in the dead bolt lockplate (1a) and, in the other arm, has a second face (23) that, in relation to said operating rotation of the follower (5) starting at the locked state of the lock, is suitably retracted with respect to the first face (16) of the rocking lever (10), there being a multiplication of this antipanic arm (12) such that it produces the course of retraction of the dead bolt appropriately before, during the same rotation of the follower (5), and so the total retraction of the latch bolt (2) is accomplished.

Provided in its constitution is that, in the trigger support (10)* (FIGS. 1 and 7), the means of blocking the operating vertical displacement of the dead bolt retaining control (8) consist of a side lug (24), which has an upper horizontal surface (27) and a lower beveled surface (28), in conjunction with which, in said dead bolt retaining control (8), the means of blocking its operating vertical displacement, which operate in conjunction with other means of the trigger (10)**, consist of an upper pivot (25), which, in relation to the extended and retracted positions of the trigger (3), is respectively aligned or not aligned in the vertical direction, this upper pivot (25) remaining respectively opposite the horizontal (27) and beveled (28) surfaces of the side lug (24). On the other hand, provided in relation to the dead bolt retaining control (8) is that the means of hooking consist of a first hook (29) that is just above the level of the tilted position of the control retaining catch (9) and suitably retracted in relation to the start of the retraction travel distance of the latch bolt (2), as is illustrated by means of FIGS. 1 and 4; the means of retention of the retracted state of the dead bolt (1) consist of an angled opening (30) that is reciprocal to said first stub (13) of the dead bolt lockplate (1a) and is situated at a level suitably lower than that of the first stub (13), in relation to said upper position of the dead bolt retaining control (8), this being illustrated in full clarity in the enlargement of FIG. 12, in which it is also seen that the means of reciprocal propulsion between it and the first stub (13) of the dead bolt lockplate (1a) consist of a ramp (31) that is made in the front side of the dead bolt retaining control (8), joined in a continuous manner with the backside edge of its angled opening (30).
sic; 7?—Trans. Note.

sic; 3?—Trans. Note.

Another feature of the invention is that said control retaining catch (9) is installed in a carriage (32) fastened in the tail end of the internal latch bolt (2) to the case of the lock, as illustrated in FIG. 4 in greater clarity.

FIGS. 1, 2, 6, and 9, together with their opportune enlarged details, illustrate the operating sequence for the automatic triggering of the lock. In the same way, FIGS. 11 and 13 and their enlarged details illustrate the resetting sequence with antipanic function. FIGS. 9 and 11 allow illustration of the illicit-entry anti-retraction function of the latch bolt (2), the means of which are treated further below, as also do the illicit-entry anti-retraction security device of the dead bolt (1) when it has only realized a part of its course of extension toward the strike plate.

We start from the position of FIG. 1, in which the lock is open and the door is released from its frame, for which the latch bolt (2) is extended, as is also the trigger (3), pushed by the first spring (19); in this position, the dead bolt retaining control (8) is stopped in its upper operating position because the upper pivot (25) of the same rests on the horizontal surface (27) of the side lug (24) formed in the support (7) of the trigger (3).

When the door is brought into its shut position in the frame, in schematic terms, the latch bolt (2) begins to retract prior to the trigger (3) doing so, so that, when the former starts to meet with the frame in order to be retracted, what occurs (FIGS. 2 and 4) is that the control retaining catch (9) has situated itself (FIG. 4) below the first hook (29) formed by the dead bolt retaining control (8) and catches the immobilization release of the latter for when, subsequently (FIG. 6), the retraction of the trigger (3) is verified, which, in turn, releases the immobilization, which has been provided up to then, as FIG. 7A clearly illustrates. In this point, it needs to be clarified that, for better visual clarity, the retracted position of the latch bolt (2) shown in FIG. 2 is not real, but may be more extended, since the trigger has not initiated its retraction.

FIG. 6 corresponds to the state in which the trigger (3) is already retracted, but the latch bolt (2) has not yet arrived in front of its strike plate in the frame. Only when this occurs is the automatic triggering brought about, which brings about the situation shown in FIG. 9; since the dead bolt retaining control (8) is now not stopped by the trigger, as soon as the latch bolt (2) projects, there is brought about the release on the part of the control retaining catch (9), the dead bolt retaining control (8) dropping by the combined action of gravity and the push of the sixth spring (44); this drop brings about the fact that the angled opening (30) releases the stop exerted on the first stub (13) of the dead bolt lockplate (1a) and that, in a continuous manner, the ramp (31) is pushed against this first stub (13), leading, finally, to the situation of FIG. 9. By means of this operational sequence, malfunctions of the known mechanisms are prevented, since the automatic triggering only takes place when the door is in its correct position.

On opening, the lock attains the resetting of the mechanism for a new automatic release of closure. The retraction of the dead bolt (1) against its fourth spring (42) causes the third stub (13) to push against the ramp (31) to bring about the rise of the dead bolt retaining control (8) until it reassumes its upper position; during this travel, the side lug (24) does not afford any obstacle, since the trigger (3) is retracted; the retaining latch (9) does not interfere either, because the dead bolt retaining control (8) itself constrains it elastically against the fifth spring (43); during this action, the design of the antipanic arm (12) results in the dead bolt (1) being totally retracted without the latch bolt (2) being so (FIG. 11), for which reason it will not yet be possible for the door to be retracted from its frame, so that it will not be possible for the dead bolt (1) to remain extended wrongly, preventing its reclosure after a hasty or disorderly exit on the part of the user. Only when the latch bolt (2) has completed its retraction is the situation of FIG. 13 reached and the door can be released from its frame.

In accordance with another feature of the invention, in the latch bolt stop (11), on both sides of the central axis (18), there extend respective members, a first (33) and a second (34), the first member (33) being capable of rotating between raised and lowered positions, respectively, in which its end continues to interfere or not interfere with the retraction travel distance of the lateral projection (35) of said carriage (32) of the tail end of the latch bolt (2) at the time when, in relation to the opening rotation of the follower (5), the end of the second member (34) is positioned directly on the peripheral dog (36) of this follower (5) or is suitably advanced toward the same at the time when, in said lowered position, the first member (33) is positioned below a second hook (37) provided in the trigger support (7), there existing a third spring (38) that is positioned at the first member (33) to counter the action produced by the opening rotation of the follower (5), which pushes the lowered position of the first member (33) against this third spring (38).

With this arrangement, there is established an anti-retraction security device of the latch bolt (2), which is illustrated by means of FIGS. 1, 9, and 10. When the door is released from the frame (FIG. 1), the latch bolt stop (11) is in non-stopped position because the second hook (37) of the trigger support (7) prevents, in opposition to the elastic action of the third spring (38), the first member (33) from being able to rise; when the trigger (3) is retracted, the second hook (37) retracts, but, since the latch bolt (2), is already somewhat retracted, it is the carriage (32) and the head itself of the latch bolt (2) that prevent said rise of the first member (33); when the door closes in the frame and projects the latch bolt (2), since the trigger (3) is retracted, the latch bolt stop (11) can still occupy the stop position that is shown in FIG. 10 and in which it should be noted that the end of the second member (34) is positioned on the peripheral dog (36) of the follower (5) in such a way that, when the opening action (with the key or the handle) is commenced, the latch bolt stop (11) is retracted before the lateral projection (35) reaches the stop position during the retraction of the latch bolt (2).

In accordance with another feature of the invention, the stop means of the dead bolt lockplate (1a) consist in the fact that the upper edge of the dead bolt lockplate (1a) forms, from front to back in a successively descending way, a first step (39), a second step (40), and a back groove (41). As FIG. 15 shows, this arrangement establishes an anti-retraction security device of the dead bolt (1) when it has projected to only a partial extent, so that, although, for illicit purposes, the back end of the strike plate of the latter has been supplemented, it cannot yet be retracted to its initial position of opening, because the transverse lug (4a) of the guard (4) has situated itself before the second step (40), pushed by the second spring (20), which constrains it to be in permanent contact under pressure against the upper end of the dead bolt lockplate (1a). The first step (39) of this dead bolt lockplate (1a) operates like an additional mechanical projecting end of the total retraction of the dead bolt (1), and the back groove (41) establishes the effective stop of the extended operating position of the same.

1. A mortise lock with automatic projection of dead bolt, particularly a lock provided with a dead bolt (1), a latch bolt (2), a trigger (3) that is situated between the dead bolt (1) and the latch bolt (2) and that, when the door is brought into its frame and when this latch bolt retracts, is operatively retractable against a first spring (19), a guard (4), a follower (5) for an actuating knob, and a cylinder (6) for a combination key, wherein the dead bolt (1) of the lock can be retracted to actuate the follower (5), can be retracted to actuate the cylinder (6), and is mounted in the back point of a dead bolt lockplate (1a), the top edge of which has several stop means of the respective retracted and extended positions of this dead bolt (1), the latch bolt (2) of the lock can be retracted to actuate the follower (5) or the cylinder (6), the trigger (3) of the lock lacks an opening in the strike plate in the doorframe, and the guard (4) of the lock has a projection (4a) transverse to the dead bolt lockplate (1a), which, by vertical displacement, is capable of operating or not operating in conjunction with said stop means of the retracted and extended positions of the dead bolt (1), characterized in that it comprises a trigger support (7), a dead bolt retaining control (8), a control retaining catch (9), a rocking lever (10), a latch bolt stop (11), and an antipanic arm (12); wherein said trigger support (7) has means capable of blocking an operating vertical slide of the dead bolt retaining control (8), said dead bolt retaining control (8) has a mount that slides vertically by gravity between respective upper and lower positions corresponding to the retracted and extended states, respectively, of dead bolt (1), said dead bolt retaining control (8) also incorporates several means of hooking that operate in conjunction with the retaining latch of the control (9), other means that operate in conjunction with said means of the trigger (3) capable of blocking its operating vertical slide, other means of retention of the retracted state of dead bolt (1) that operate in conjunction with a first stub (13) of the dead bolt lockplate (1a), and other means of reciprocal propulsion with respect to this first stub (13) of the dead bolt lockplate (1a); said control retaining catch (9) travels with the latch bolt (2) and has a tilting mount that is transverse to the plane of the dead bolt retaining control (8) and that operates between a tilted position situated just below the means of hooking of the dead bolt retaining control (8) and a non-tilted position against a spring that is held at its spring excursion; said rocking lever (10) has an arm provided with a guide track (14), in which a second stub (15), installed in the guard (4), moves in an adjusting manner, and, in its other arm, has a first face (16), which, in relation to the rotation of the opening action of the lock in the locked state, adopts a non-tilted position, pushed by a second spring (20), in which it is positioned in front of a peripheral projection (17) of the follower (5), said latch bolt stop (11) has a respective tilting mount on a central axis (18) and has several means capable of interfering or not interfering with the retraction of the latch bolt (2) to determine respective positions of stopping and release, and said antipanic arm (12) has a tilting first-degree dead-bolt mount with an articulation (21) that is in common with that of the rocking lever (10) and has an arm positioned in front of a third stub (22) installed in the dead bolt lockplate (1a) and, in the other arm, has a second face (23) that, in relation to said operating rotation of the follower (5) starting at the locked state of the lock, is suitably retracted with respect to the first face (16) of the rocking lever (10), there being a multiplication of this antipanic arm (12) such that it produces the course of retraction of the dead bolt appropriately before, during the same rotation of the follower (5), and so the total retraction of the latch bolt (2) is accomplished.

2. A mortise lock with automatic projection of dead bolt according to the preceding claim, further characterized in that, in said trigger support (7), the means of blocking the operating vertical displacement of the dead bolt retaining control (8) consist of a side lug (24) that has an upper horizontal surface (27) and a lower beveled surface (28).

3. A mortise lock with automatic projection of dead bolt according to the preceding claims, further characterized in that, in said dead bolt retaining control (8), the means of hooking consist of a first hook (29) that is just above the level of the tilted position of the control retaining catch (9) and suitably retracted in relation to the start of the retraction travel distance of the latch bolt (2).

4. A mortise lock with automatic projection of dead bolt according to the preceding claims, further characterized in that, in said dead bolt retaining control (8), the means of blocking its operating vertical displacement, which operate in conjunction with other means of the trigger (3), consist of an upper pivot (25), which, in relation to the extended and retracted positions of the trigger (3), remains respectively aligned or not aligned in the vertical direction, this upper pivot (25) remaining respectively opposite the horizontal (27) and beveled (28) surfaces of the side lug (24).

5. A mortise lock with automatic projection of dead bolt according to the preceding claims, further characterized in that, in said dead bolt retaining control (8), the means of retention of the retracted state of the dead bolt (1) consist of an angled opening (30) that is reciprocal to said first stub (13) of the dead bolt lockplate (1a) and is situated at a level suitably lower than that of the first stub (13), in relation to said upper position of the dead bolt retaining control (8),

6. A mortise lock with automatic projection of dead bolt according to the preceding claims, further characterized in that, in said dead bolt retaining control (8), the means of reciprocal propulsion between it and the first stub (13) of the dead bolt lockplate (1a) consist of a ramp (31) that is made in the front side of the dead bolt retaining control (8), joined in a continuous manner with the backside edge of its angled opening (30).

7. A mortise lock with automatic projection of dead bolt according to the preceding claims, further characterized in that said control retaining catch (9) is installed in a carriage (32) fastened in the tail end of the internal latch bolt (2) to the case of the lock.

8. A mortise lock with automatic projection of dead bolt according to the preceding claims, further characterized in that, in the latch bolt stop (11), on both sides of the central axis (18), there extend respective members, a first (33) and a second (34), the first member (33) being capable of rotating between raised and lowered positions, respectively, in which its end interferes or does not interfere with the retraction travel distance of a lateral projection (35) of said carriage (32) of the tail end of the latch bolt (2) at the time when, in relation to the opening rotation of the follower (5), the end of the second member (34) is positioned directly on a peripheral dog (36) of this follower (5) or is suitably advanced toward the same at the time when, in said lowered position, the first member (33) is positioned below a second hook (37) provided in the trigger support (7), there existing a third spring (38) that is positioned at the first member (33) to counter the action produced by the opening rotation of the follower (5), which pushes the lowered position of the first member (33) against this third spring (38).

9. A mortise lock with automatic projection of dead bolt according to the preceding claims, further characterized in that the stop means of the dead bolt lockplate (1a) consist in the fact that the upper edge of the dead bolt lockplate (1a) forms, from front to back in a successively descending way, a first step (39), a second step (40), and a back groove (41).
